(19) United States
(12) Patent Application Publication
(10) Pub. No.: US 2025/0384681 A1
(43) Pub. Date: Dec. 18, 2025

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventors: KATSUTOSHI ANDO, KANAGAWA (JP); MASAYA KIMURA, KANAGAWA (JP)

(21) Appl. No.: 18/879,945

(22) PCT Filed: Jul. 6, 2023
(86) PCT No.: PCT/JP2023/025066

§ 371 Date: Dec. 30, 2024

(30) Foreign Application Priority Data
Jul. 20, 2022 (JP) 2022-115676

(51) Int. Cl. G06V 10/98; G06V 10/30; G06V 10/774; G06V 10/776; G06V 10/82

(52) U.S. Cl. CPC G06V 10/98; G06V 10/7747; G06V 10/82; G06V 10/30; G06V 10/776

(57) ABSTRACT

The present technology relates to an information processing device, an information processing method, and a program that makes it possible to improve inference accuracy of inference processing for an inference image to be input. Inference processing is performed on an input inference image, and an image quality of the inference image is corrected based on an image quality of a teacher image used for learning in an inference unit.

### TECHNICAL FIELD

The present technology relates to an information processing device, an information processing method, and a program, and particularly, relates to an information processing device, an information processing method, and a program that makes it possible to improve inference accuracy of inference processing for an inference image to be input.

### BACKGROUND ART

PTL 1 discloses a technology for optimizing sensor parameters based on an identification classification result from an identification device that identifies an object in an image acquired by a sensor.

### CITATION LIST

### Patent Literature

### PTL 1

JP 2021-144689A

### SUMMARY

### Technical Problem

The inference accuracy of inference processing for an input inference image is depends on the image qualities of teacher images used for learning in the inference processing, and thus it is difficult to improve the inference accuracy even if the operation of a sensor that acquires the inference image is adjusted based on the inference results.

The present technology has been made in view of such a situation, and makes it possible to improve the inference accuracy of inference processing for an inference image to be input.

### Solution to Problem

An information processing device or a program of a first aspect of the present technology is an information processing device including: an inference unit that performs inference processing on an input inference image; and a processing unit that corrects an image quality of the inference image based on an image quality of a teacher image used for learning in the inference unit. Or, it is a program for causing a computer to function as such an information processing device.

An information processing method according to the first aspect of the present technology is an information processing method performed by an information processing device that includes an inference unit and a processing unit, the information processing method including: by the inference unit, performing inference processing on an input inference image; and by the processing unit, correcting an image quality of the inference image based on an image quality of a teacher image used for learning in the inference unit.

In the information processing device, the information processing method, and the program according to the first aspect of the present technology, inference processing is performed on an input inference image, and an image quality of the inference image is corrected based on an image quality of a teacher image used for learning.

An information processing device according to a second aspect of the present technology is an information processing device including a supply unit that supplies, to an inference device that implements an inference model generated by a machine learning technology, information on an image quality of a teacher image used to learn an inference model.

In the information processing device according to the second aspect of the present technology, to an inference device that implements an inference model generated by a machine learning technology, information on an image quality of a teacher image used to learn the inference model is supplied.

### BRIEF DESCRIPTION OF DRAWINGS

FIG. 1 is a block diagram illustrating a configuration example of an inference system according to a first embodiment to which the present technology is applied.

FIG. 2 is a block diagram illustrating a configuration example of an inference system according to a second embodiment to which the present technology is applied.

FIG. 3 is a block diagram illustrating a configuration example of an inference system according to a third embodiment to which the present technology is applied.

FIG. 4 is a block diagram illustrating a configuration example of an inference system according to a fourth embodiment to which the present technology is applied.

FIG. 5 is a diagram illustrating an inference image quality correction method based on a certainty factor.

FIG. 6 is a diagram illustrating the inference image quality correction method based on a certainty factor.

FIG. 7 is a diagram illustrating an inference image quality correction method based on an inference result.

FIG. 8 is a diagram illustrating an inference image quality correction method (first example) based on a teacher image quality.

FIG. 9 is a diagram illustrating an inference image quality correction method (second example) based on a teacher image quality.

FIG. 10 is a diagram illustrating an inference image quality correction method (third example) based on a teacher image quality.

FIG. 11 is a diagram illustrating types of pre-processing parameters available for correction of inference image quality.

FIG. 12 is a block diagram illustrating a configuration example of an embodiment of a computer to which the present technology is applied.

### DESCRIPTION OF EMBODIMENTS

Embodiments of the present technology will be described below with reference to the drawings.

### Inference System According to Present Embodiment

### Inference System According to First Embodiment

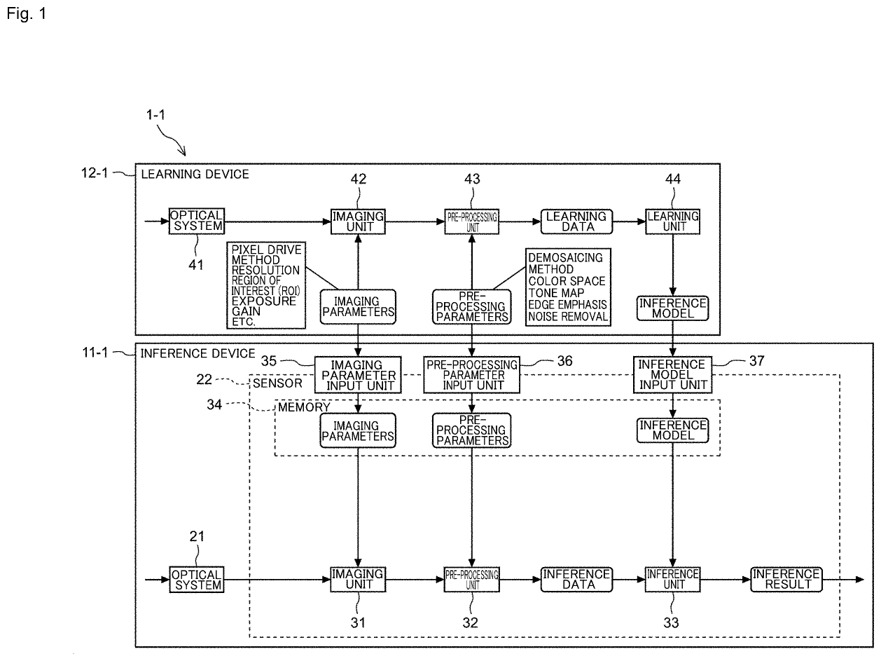

FIG. 1 is a block diagram illustrating a configuration example of an inference system according to a first embodiment to which the present technology is applied. In FIG. 1, the inference system 1-1 according to the first embodiment is a system that generates an inference model using learning data and performs inference, such as object detection, on a captured image captured by an imaging element (sensor) using the generated learning model.

The inference system 1-1 includes an inference device 11-1 and a learning device 12-1. The inference device 11-1 captures a subject image formed on the light receiving surface of a sensor 22 described later, and performs inference processing on the resulting captured image to detect the presence or absence of a predetermined type of object (recognition target) such as a person (person image) and an image region in which the recognition target is present. The contents of the inference processing are not limited to specific processing, but the inference processing in the present embodiment detects the position (image region) of a person as a recognition target. In addition, in the embodiment, the sensor 22 has an imaging function to serve as an imaging element and an inference function for performing inference processing using an inference model. An inference result by the sensor 22 is supplied from the sensor 22 to a computation processing unit (such as an application processor) at the subsequent stage, and is used for any processing according to a program executed in the computation processing unit.

The learning device 12-1 generates an inference model to be used in the inference system 1-1. The inference model is a learning model having a structure of a neural network (NN) generated by using, for example, a machine learning technology. Examples of the NN include various forms of an NN such as a deep neural network (DNN). In the inference model, the values of various parameters contained in the inference model are adjusted and set by processing called learning using teacher images as a large amount of learning data (learning data). Thus, the inference model is generated. The learning device 12-1 generates or acquires a large amount of learning data, and generates an inference model using the learning data. The learning device 12-1 supplies the inference device 11-1 with data (computation algorithms and various parameters for the inference model) for implementing the generated inference model in the sensor 22 of the inference device 11-1. The learning device 12-1 also supplies the inference device 11-1 with image quality information (teacher image information) of the learning data (teacher images) used to generate the inference model. The inference device 11-1 adjusts the image quality of the captured image to be input to the inference model to the image quality of the teacher image based on the teacher image quality information supplied from the learning device 12-1. This improves the inference accuracy of the inference model.

The inference device 11-1 includes an optical system 21 and the sensor 22. The optical system 21 collects light from a subject in a subject space (three-dimensional space) and forms an optical image of the subject on the light receiving surface of the sensor. The sensor 22 includes an imaging unit 31, a pre-processing unit 32, an inference unit 33, a memory 34, an imaging parameter input unit 35, a pre-processing parameter input unit 36, and an inference model input unit 37. The imaging unit 31 captures (photoelectrically converts) the optical image of the subject formed on the light receiving surface to acquire a captured image as an electrical signal, and supplies the captured image to the pre-processing unit 32. The pre-processing unit 32 performs pre-processing of the captured image from the imaging unit 31, such as demosaicing, white balance, contour correction (edge emphasis, etc.), noise removal, shading correction, distortion correction, gradation correction (gamma correction, tone management, tone mapping, etc.), and color correction. The pre-processing unit 32 supplies the inference unit 33 with the captured image on which the pre-processing has been performed as inference data. However, the processing of the pre-processing unit 32 is not limited to this.

The inference unit 33 performs inference such as object detection using an inference model for the inference data (captured image) supplied from the pre-processing unit 32. The inference model to be used in the inference unit 33 is an inference model generated by the learning device 12-1, and data of the inference model, that is, data for performing inference processing using the inference model (algorithm, data of various parameters) is stored in advance in the memory 34. The inference unit 33 performs the inference processing using the data of the inference model (algorithm, data of parameters, etc.) stored in the memory 34. The inference unit 33 outputs an inference result to a computation processing unit or the like external to the sensor 22. For example, in the inference processing of the present embodiment, the inference unit 33 outputs the position (image region) of a detected person in the captured image (inference data) as an inference result. In the inference, additional information such as a certainty factor of the inference result (the likelihood that an object determined to be a person is the person) is generally calculated, and such additional information is also output as an inference result as necessary. The inference unit 33 (inference model) herein is mounted in the sensor 22 (semiconductor chip) that is the same as where the imaging unit 31 is mounted, but may be mounted in a sensor separate from the imaging unit 31. Data of the inference model is stored (deployed) in the sensor 22 so as to be rewritable from the outside, but for example, the algorithm (program) of the inference model may be stored in the sensor 22 in a hardwired and unrewritable manner while only the parameters for the inference model may be stored so as to be rewritable from the outside, or all data of the inference model may be stored in the sensor 22 so as to be unrewritable.

The memory 34 is a storage unit included in the sensor 22, and stores data to be used by the sensor 22. The imaging parameter input unit 35 receives data of imaging parameters supplied from the learning device 12-1 and stores that data in the memory 34. The pre-processing parameter input unit 36 receives data of pre-processing parameters supplied from the learning device 12-1 and stores that data in the memory 34. The inference model input unit 37 receives data of an inference model supplied from the learning device 12-1 and stores that data in the memory 34. The imaging parameter input unit 35, the pre-processing parameter input unit 36, and the inference model input unit 37 do not need to be physically separate from one another, and may be a common input unit. The imaging parameters, the pre-processing parameters, and the inference model are not limited to being supplied from the learning device 12-1, but may be supplied to the inference device 11-1 from any device. The data of the imaging parameters and the data of the pre-processing parameters will be described later.

The learning device 12-1 includes an optical system 41, an imaging unit 42, a pre-processing unit 43, and a learning unit 44. The optical system 41 collects light from a subject in a subject space (three-dimensional space) and forms an optical image of the subject on the light-receiving surface of the imaging unit 42. The imaging unit 42 captures (photoelectrically converts) an optical image of the subject formed on the light-receiving surface to acquire a captured image as an electrical signal, and supplies the captured image to the pre-processing unit 43. The pre-processing unit 43 performs pre-processing on the captured image from the imaging unit 42 in the same manner as the pre-processing unit 32 of the inference device 11-1. The pre-processing unit 43 supplies the learning unit 44 with the captured image on which the pre-processing has been preformed as learning data (teacher image). The learning unit 44 performs inference model learning using a large amount of learning data from the pre-processing unit 43, and generates an inference model to be used in the inference device 11-1. Here, the learning data (teacher image) to be used for the inference model learning is not limited to being supplied to the learning unit 44 on the configuration of the learning device 12-1 in FIG. 1. For example, captured images acquired from a plurality of types of optical systems 41 or imaging units 42 may be supplied to the learning unit 44 as teacher images, or images (artificial images) such as computer graphics or illustrations rather than real images may be supplied as teacher images to the learning unit 44. In other words, the learning device 12-1 may not include the optical system 41 and the imaging unit 42. The learning unit 44 supplies the generated inference model to the inference device 11-1.

The data of the imaging parameters and the data of the pre-processing parameters herein, which are supplied from the learning device 12-1 to the inference device 11-1 and stored in the memory 34, are one form of image quality information (teacher image quality information) that indicates the image quality of the teacher images used by the learning unit 44 for the inference model learning. The imaging parameters are parameters that specify the operation (or control) of the imaging unit 42, and are parameters that specify, for example, the pixel drive method, resolution, region of interest (ROI), exposure (time), gain, and the like, for the imaging unit 42. The imaging parameters are parameters that specify the operation of the imaging unit 42 when the imaging unit 42 captures a captured image (hereinafter also referred to as a teacher image) serving as learning data.

However, the imaging parameters may not be information recognized at the time of or before capturing a teacher image, but may be information recognized after capturing a teacher image based on information added to the teacher image, or the like.

The pre-processing parameters are parameters that specify the operation (processing contents) of the pre-processing unit 43, and are parameters that specify the content of pre-processing performed on a teacher image by the pre-processing unit 43. The pre-processing parameters specify the contents of pre-processing, such as demosaic, white balance, contour correction (edge emphasis, etc.), noise removal, shading correction, distortion correction, gradation correction (gamma correction, tone management, tone mapping, etc.), color correction, and the like. However, the pre-processing parameters may not be information recognized at the time of or before pre-processing when the pre-processing is performed on a teacher image, but may be information added to a teacher image or information recognized after the pre-processing of a teacher image through analysis of the teacher image.

These imaging parameters and pre-processing parameters are supplied from the learning device 12-1 (a supply unit, not illustrated) to the imaging parameter input unit 35 and the pre-processing parameter input unit 36 of the inference device 11-1 as teacher image quality information that indicates the image quality of a teacher image used in generating (learning) an inference model used in the inference device 11-1, and are stored in the memory 34. The imaging parameters and the pre-processing parameters may each include not only one element value but also a plurality of element values (also simply referred to as parameters). In addition, since a large number of teacher images are used to learn an inference model, the imaging parameters and the pre-processing parameters for each teacher image may differ depending on their element values. In this case, for each of the element values of the imaging parameters and the pre-processing parameters, statistical values are used such as an average value, a minimum value, a maximum value, a variance value, a mode value, and a fluctuation range for a plurality of teacher images.

In response to this, the imaging unit 31 and the pre-processing unit 32 of the inference device 11-1 perform imaging and pre-processing according to the imaging parameters and the pre-processing parameters, which are stored in the memory 34, respectively. As a result, the image quality of the inference data (inference image) to be input to the inference unit 33 is corrected so that it is substantially the same as the image quality of the teacher image (so that the image quality of the inference image is adjusted to the image quality of the teacher image), thereby improving the inference accuracy of the inference unit 33. For example, if there is a limit to increasing the hardware resources as in the case where an inference model is implemented in the sensor 22, it is necessary to light-weight the inference model (to reduce the amount of calculation by reducing the number of parameters, etc.). Since there is a trade-off between the inference accuracy and the amount of calculation of the inference model, the present technology is particularly effective because it can prevent a degradation in inference accuracy or improve the inference accuracy while light-weighting the inference model. In other words, according to the present technology, the image quality (teacher image quality) of a teacher image used to learn an inference model is limited to a certain fluctuation range in light-weighting the inference model, and therefore, for inference data (inference image) having an image quality that is substantially the same as the teacher image quality, the inference accuracy of the inference model is improved as well as the inference model being light-weighted. For example, for an inference image being a bright image captured in daylight, the inference model is light-weighted and the inference accuracy is improved by using an image with bright image quality as a teacher image.

On the other hand, for an inference image having an image quality significantly different from that of the teacher image, the inference accuracy is degraded. Therefore, in the present technology, teacher image quality information of the teacher images is acquired in advance, and the image quality of the inference image is corrected based on the teacher image quality information so that the inference image has substantially the same image quality as the teacher images, thereby preventing a degradation of the inference accuracy due to the light-weighted inference model.

In PTL 1 (JP 2021-144689 A), optimal sensor parameters are determined based on an inference result, but in PTL 1, the inference image and the teacher image cannot be adjusted to have the same image quality (properties). In addition, the inference image cannot be appropriately corrected only from the inference result, and it is difficult to perform optimal correction for an unknown input image (inference image) that changes from moment to moment. In contrast, according to the present technology, the teacher image(s) and the inference image are adjusted to have the same image quality (properties) so that they are easy to infer, and therefore the inference accuracy can be improved. In addition, it is also possible to feed back an inference result of inference processing as in a third embodiment described later, and therefore the inference image can be corrected (adjusted) to an optimal image quality regardless of the type of input image (inference image) and its changes.

### Inference System According to Second Embodiment

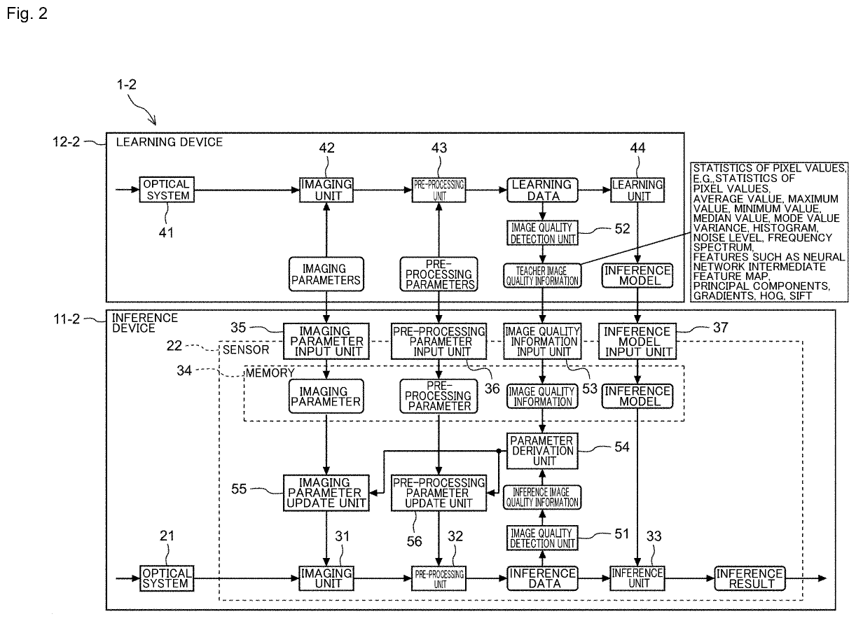

FIG. 2 is a block diagram illustrating a configuration example of an inference system according to a second embodiment to which the present technology is applied. In the figure, the same reference numerals are given to the parts that are in common with those of the inference system 1-1 in FIG. 1, and detailed description thereof will be omitted as appropriate. An inference system 1-2 according to the second embodiment in FIG. 2 includes an inference device 11-2 and a learning device 12-2, which correspond to the inference device 11-1 and the learning device 12-1 of the inference system 1-1 in FIG. 1, respectively. The inference device 11-2 in FIG. 2 includes an optical system 21 and a sensor 22, and the sensor 22 includes an imaging unit 31, a pre-processing unit 32, an inference unit 33, a memory 34, an imaging parameter input unit 35, a pre-processing parameter input unit 36, an inference model input unit 37, an image quality detection unit 51, an image quality information input unit 53, a parameter derivation unit 54, an imaging parameter update unit 55, and a pre-processing parameter update unit 56. The learning device 12-2 in FIG. 2 includes an optical system 41, an imaging unit 42, a pre-processing unit 43, a learning unit 44, and an image quality detection unit 52.

Thus, the inference device 11-2 in FIG. 2 is in common with the inference device 11-1 in FIG. 1 in that the inference device 11-2 includes the optical system 21 and the sensor 22 in the inference device 11-1 in FIG. 1, and includes the imaging unit 31, the pre-processing unit 32, the inference unit 33, the memory 34, the imaging parameter input unit 35, the pre-processing parameter input unit 36, and the inference model input unit 37 of the sensor 22 in FIG. 1. On the other hand, the inference device 11-2 in FIG. 2 differs from the inference device 11-1 in FIG. 1 in that the image quality detection unit 51, the image quality information input unit 53, the parameter derivation unit 54, the imaging parameter update unit 55, and the pre-processing parameter update unit 56 are newly added. The learning device 12-2 in FIG. 2 is in common with the learning device 12-1 in FIG. 1 in that the learning device 12-2 includes the optical system 41, the imaging unit 42, the pre-processing unit 43, and the learning unit 44. On the other hand, the learning device 12-2 in FIG. 2 differs from the learning device 12-1 in FIG. 1 in that the image quality detection unit 52 is newly added.

In the inference system 1-2 of FIG. 2, the image quality detection unit 52 of the learning device 12-2 detects statistics or features of learning data (teacher images) and supplies them to the inference device 11-2 as teacher image quality information. Examples of the statistics of the learning data include, as statistics of pixel values, an average value, a maximum value, a minimum value, a median value, a mode value, a variance, a histogram, a noise level, a frequency spectrum, and the like. The features of the learning data include features such as a neural network intermediate feature map, principal components, gradients, histograms of oriented gradients (HOG), and scale-invariant feature transform (SIFT).

In the inference device 11-2 of FIG. 2, the image quality information input unit 53 of the sensor 22 acquires the teacher image quality information from the image quality detection unit 52 of the learning device 12-2, and stores that information in the memory 34. The image quality detection unit 51 of the sensor 22 detects statistics or features of the inference data (inference image) from the pre-processing unit 32 in the same manner as the image quality detection unit 52 of the learning device 12-2, and supplies them as inference image quality information to the parameter derivation unit 54.

The parameter derivation unit 54 reads out the teacher image quality information stored in the memory 34, and compares the teacher image quality information with the inference image quality information from the image quality detection unit 52. As a result, the parameter derivation unit 54 derives the imaging parameters and the pre-processing parameters, which are to be updated, so that the inference image quality is substantially the same as the teacher image quality, and supplies them to the imaging parameter update unit 55 and the pre-processing parameter update unit 56, respectively. The imaging parameter update unit 55 reads out data of imaging parameters from the memory 34, updates the imaging parameters to be updated that are supplied from the parameter derivation unit 54, and supplies the updated imaging parameters to the imaging unit 31. Among the imaging parameters acquired from the memory 34, the imaging parameters other than the imaging parameters to be updated are supplied to the imaging unit 31. The pre-processing parameter update unit 56 reads out data of pre-processing parameters from the memory 34, updates the pre-processing parameters to be updated that are supplied from the parameter derivation unit 54, and supplies the updated parameters to the pre-processing unit 32. Among the pre-processing parameters acquired from the memory 34, the pre-processing parameters other than the pre-processing parameters to be updated are supplied to the pre-processing unit 32.

For example, when an average brightness value in the teacher image quality information is different from an average brightness value in the inference image quality information, the parameter derivation unit 54 supplies, to the pre-processing unit 32 via the pre-processing parameter update unit 56, a value of (the average brightness value in the teacher image quality information)/(the average brightness value in the inference image quality information) as a brightness gain to be supplied to the pre-processing unit 32. Accordingly, the inference image is corrected so that the average brightness value of the inference image is substantially the same as the average brightness value of the teacher image. As a result, the inference image to be input to the inference unit 33 is corrected to have substantially the same image quality as that of the teacher image, thereby improving the inference accuracy.

### Inference System According to Third Embodiment

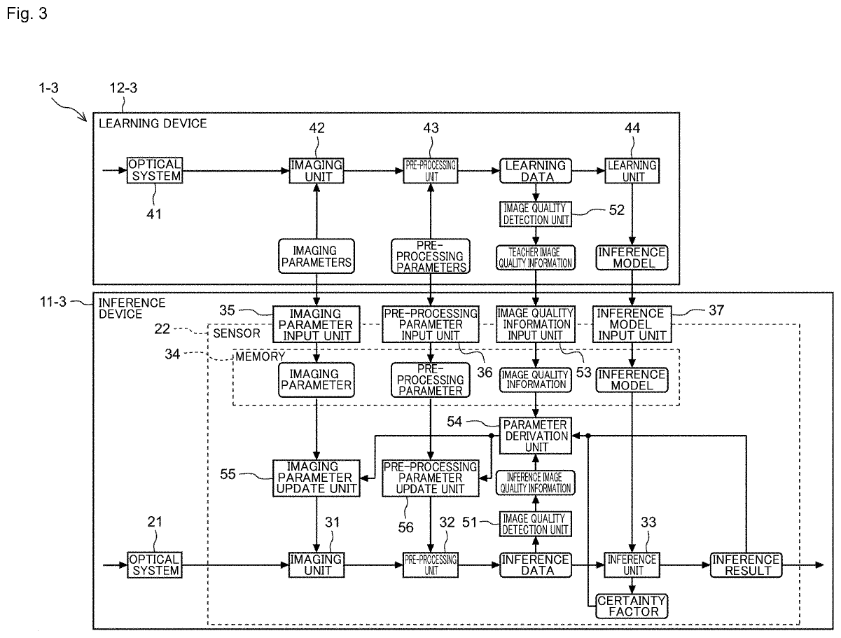

FIG. 3 is a block diagram illustrating a configuration example of an inference system according to a third embodiment to which the present technology is applied. In the figure, the same reference numerals are given to the parts that are in common with those of the inference system 1-2 in FIG. 2, and detailed description thereof will be omitted as appropriate. An inference system 1-3 according to the third embodiment in FIG. 3 includes an inference device 11-3 and a learning device 12-3, which correspond to the inference device 11-2 and the learning device 12-2 of the inference system 1-2 in FIG. 2, respectively. The inference device 11-3 in FIG. 3 includes an optical system 21 and a sensor 22, and the sensor 22 includes an imaging unit 31, a pre-processing unit 32, an inference unit 33, a memory 34, an imaging parameter input unit 35, a pre-processing parameter input unit 36, an inference model input unit 37, an image quality detection unit 51, an image quality information input unit 53, a parameter derivation unit 54, an imaging parameter update unit 55, and a pre-processing parameter update unit 56. The learning device 12-3 in FIG. 3 includes an optical system 41, an imaging unit 42, a pre-processing unit 43, a learning unit 44, and an image quality detection unit 52.

Accordingly, the inference device 11-3 in FIG. 3 includes the optical system 21 and the sensor 22 in the inference device 11-1 in FIG. 1, and is common with the inference device 11-2 in FIG. 2 in that the inference device 11-3 includes the imaging unit 31, the pre-processing unit 32, the inference unit 33, the memory 34, the imaging parameter input unit 35, the pre-processing parameter input unit 36, the inference model input unit 37, the image quality detection unit 51, the image quality information input unit 53, the parameter derivation unit 54, the imaging parameter update unit 55, and the pre-processing parameter update unit 56 of the sensor 22 in FIG. 2. On the other hand, the inference device 11-3 in FIG. 3 differs from the inference device 11-2 in FIG. 2 in that an inference result and information on a certainty factor from the inference unit 33 are supplied to the parameter derivation unit 54. The learning device 12-3 in FIG. 3 has no difference from the learning device 12-2 in FIG. 2, and is in common with the learning device 12-2 in FIG. 2.

In the inference system 1-3 of FIG. 3, the inference unit 33 of the inference device 11-3 supplies an inference result and information on a certainty factor to the parameter derivation unit 54. As in the case of FIG. 2, the parameter derivation unit 54 derives the imaging parameters and pre-processing parameters to be updated so that the teacher image quality and the inference image quality are substantially the same. Furthermore, the parameter derivation unit 54 updates the derived imaging parameters and pre-processing parameters based on the inference result and certainty factor from the inference unit 33, and supplies them to the imaging unit 31 and the pre-processing unit 32 via the imaging parameter update unit 55 and the pre-processing parameter update unit 56. For example, when the inference unit 33 performs inference processing of detecting the position (image region) of a person in the inference image, the imaging parameters are updated to those with the image region of the detected person as a region of interest (ROI). The parameter derivation unit 54 detects an upward or downward trend in the certainty factor from the inference unit 33 by changing, for example, in small increments a parameter related to the brightness of the inference image among the imaging parameters or pre-processing parameters. Then, the parameter derivation unit 54 changes the parameters in small increments so as to increase the certainty factor, and when an upward trend in the certainty factor is no longer detected, stops changing the parameters. Thus, the inference image is corrected so as to increase the certainty factor, thereby improving the inference accuracy.

### Inference System According to Fourth Embodiment

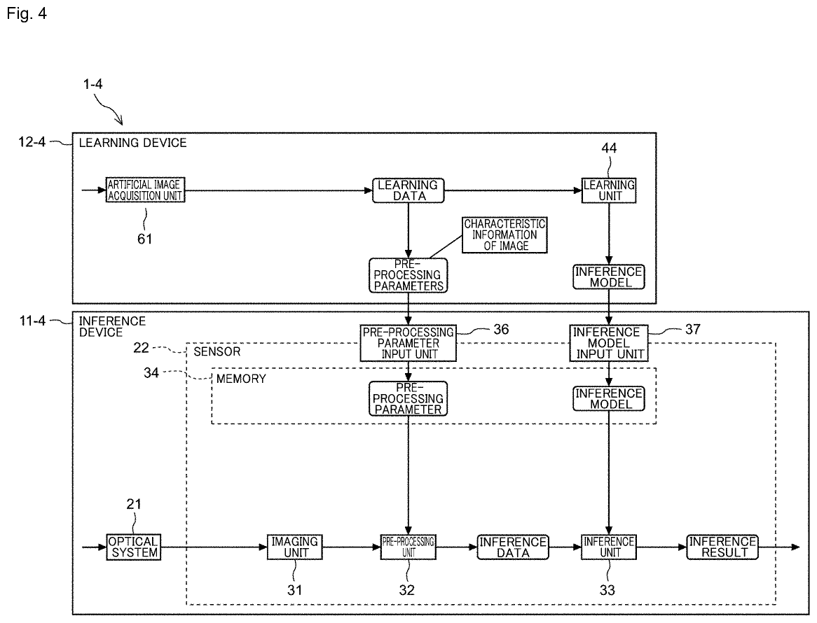

FIG. 4 is a block diagram illustrating a configuration example of an inference system according to a fourth embodiment to which the present technology is applied. In the figure, the same reference numerals are given to the parts that are in common with those of the inference system 1-1 in FIG. 1, and detailed description thereof will be omitted as appropriate. An inference system 1-4 according to the fourth embodiment in FIG. 4 includes an inference device 11-4 and a learning device 12-4, which correspond to the inference device 11-1 and the learning device 12-1 of the inference system 1-1 in FIG. 1, respectively. The inference device 11-4 in FIG. 4 includes an optical system 21 and a sensor 22, and the sensor 22 includes an imaging unit 31, a pre-processing unit 32, an inference unit 33, a memory 34, a pre-processing parameter input unit 36, and an inference model input unit 37. The learning device 12-4 in FIG. 4 includes a learning unit 44 and an artificial image acquisition unit 61.

Thus, the inference device 11-4 in FIG. 4 is in common with the inference device 11-1 in FIG. 1 in that the inference device 11-4 includes the optical system 21 and the sensor 22 in the inference device 11-1 in FIG. 1, and includes the imaging unit 31, the pre-processing unit 32, the inference unit 33, the memory 34, the pre-processing parameter input unit 36, and the inference model input unit 37 of the sensor 22 in FIG. 1. On the other hand, the inference device 11-4 in FIG. 4 differs from the inference device 11-1 in FIG. 1 in that the inference device 11-4 does not include the imaging parameter input unit 35 in FIG. 1. The learning device 12-4 in FIG. 4 is in common with the learning device 12-1 in FIG. 1 in that the learning device 12-4 includes the learning unit 44 in FIG. 1. On the other hand, the learning device 12-4 in FIG. 4 differs from the learning device 12-1 in FIG. 1 in that the learning device 12-4 does not include the optical system 41, the imaging unit 42, or the pre-processing unit 43, and in that the artificial image acquisition unit 61 is newly added.

In the inference system 1-4 of FIG. 4, the artificial image acquisition unit 61 of the learning device 12-4 acquires an artificially generated image (artificial image) such as a computer graphic or an illustration, and supplies that image as learning data (teacher image) to the learning unit 44. The learning unit 44 does not use a real image as learning data (teacher image) as in FIG. 1 to learn an inference model, but uses an artificial image to learn an inference model. The learning device 12-4 supplies a pre-processing parameter(s) corresponding to characteristic information (image quality information) of the learning data (artificial image) to the inference device 11-4. The characteristic information of the artificial image may be acquired from information of the artificial image when generated, or may be acquired by analyzing and interpreting the learning data (teacher image). The artificial image as the teacher image supplied to the learning unit 44 and used to learn an inference model is not limited to an image in which the entire image is artificially generated. From the viewpoint that it is difficult to collect a large number of portraits due to privacy issues, examples of the artificial image include a composite image of an artificially generated image and a real image, such as when the foreground (person) is an artificially generated image and the background is a real image. The examples of the artificial image also include a composite image of a plurality of different real images, such as when the foreground (person) and the background are different real images. In other words, the artificial image may include an image that has been artificially processed in part or in whole, rather than a real image.

In the inference device 11-4 in FIG. 4, the pre-processing parameter input unit 36 of the sensor 22 acquires pre-processing parameters from the learning device 12-2, and stores them in the memory 34. The pre-processing unit 32 performs pre-processing according to the pre-processing parameters stored in the memory 34, thereby correcting the captured image from the imaging unit 31 to an artificial image having a characteristic (image quality) that is substantially the same as that of the teacher image(s), and supplies the corrected image as inference data (inference image) to the inference unit 33. This allows the inference unit 33 to receive an inference image with an image quality that is substantially the same as that of the teacher images used to learn the inference model, thereby improving the inference accuracy.

In the inference systems 1-1 to 1-4 according to the first to fourth embodiments described above, a plurality of methods (inference image quality correction methods) have been described by way of example for correcting the image quality of the inference image to be input to the inference unit (inference model) in order to improve the inference accuracy. The inference systems 1-1 to 1-4 each exemplify an aspect in which one or more inference image quality correction methods are applied, and the present technology is not limited to the first to fourth embodiments. Any one or more of the plurality of inference image quality correction methods can be employed in an inference system. Each inference image quality correction method will be described individually below.

### Inference Image Quality Correction Method Based on Certainty Factor

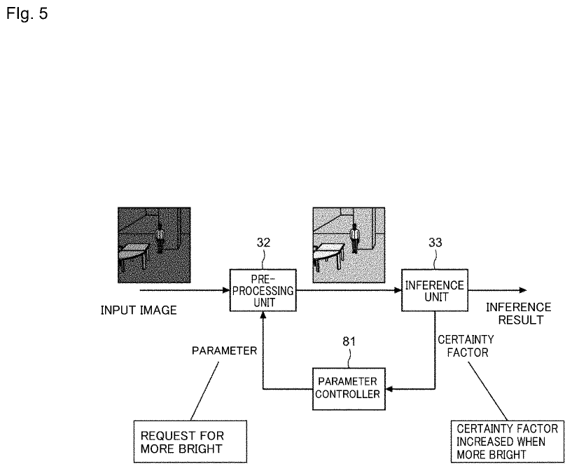

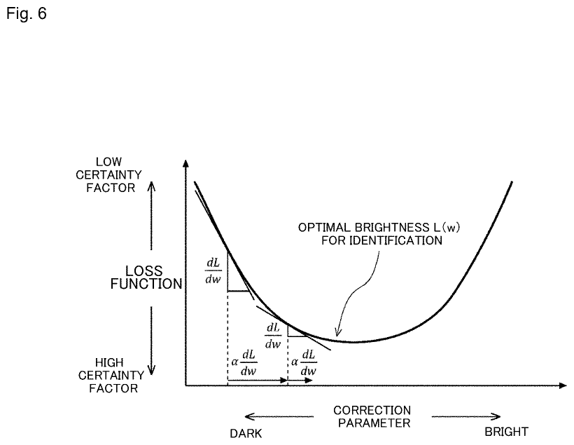

FIGS. 5 and 6 are diagrams illustrating an inference image quality correction method based on a certainty factor. In FIG. 5, a pre-processing unit 32 and an inference unit 33 correspond to the pre-processing unit 32 and the inference unit 33 of the inference device 11-3 in the third embodiment illustrated in FIG. 3. In FIG. 5, a parameter controller 81 includes the parameter derivation unit 54 and the pre-processing parameter update unit 56 of the inference device 11-3 in the third embodiment illustrated in FIG. 3.

For example, when the parameter controller 81 acquires the certainty factor for the inference result from the inference unit 33, the parameter controller 81 calculates the inverse of the moving average as a loss function L. The parameter controller 81 uses a predetermined parameter among the pre-processing parameters as a correction parameter w, changes the correction parameter w in a direction in which the loss function L becomes smaller (in a direction in which the certainty factor becomes higher), and supplies the changed correction parameter w to the pre-processing unit 32. If a new captured image (inference image) is to be input from the imaging unit 31 (see FIG. 3) to the pre-processing unit 32 at a constant period, the change in the correction parameter w in the pre-processing unit 32 is reflected in the inference image to be input to the pre-processing unit 32 next. For example, it is assumed that the correction parameter w is a parameter that affects the brightness of the inference image, and the loss function L changes with respect to the correction parameter was illustrated in FIG. 6. If the loss function L changes by ΔL when the correction parameter w is changed by Aw, the parameter controller 81 then changes the correction parameter w by a (ΔL/Δw)=α·(dL/dw) in a direction in which ΔL becomes negative, and with a being a constant. By repeatedly changing the correction parameter w in this manner, the correction parameter w is changed so that the loss function L is minimized, and the brightness of the inference image is adjusted so that the certainty factor is increased (to reach the optimal state). The inference image to be input to the pre-processing unit 32 changes from moment to moment, and the correction parameter w also continues to be changed accordingly so as to increase the certainty factor. In FIG. 5, the parameter controller 81 is configured to change the pre-processing parameters of the pre-processing unit 32. However, the parameter controller 81 may be configured to change the imaging parameters of the imaging unit 31 in a similar manner, and may be configured to also change parameters other than those related to brightness in a similar manner so as to increase the certainty factor.

### Inference Image Quality Correction Method Based on Inference Result

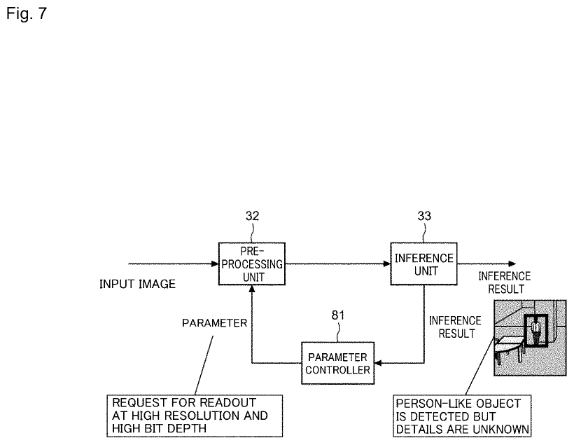

FIG. 7 is a diagram illustrating an inference image quality correction method based on an inference result. In FIG. 7, an imaging unit 31 and an inference unit 33 correspond to the imaging unit 31 and the inference unit 33 of the inference device 11-3 in the third embodiment illustrated in FIG. 3. In FIG. 7, a parameter controller 81 includes the parameter derivation unit 54 and the imaging parameter update unit 55 of the inference device 11-3 in the third embodiment illustrated in FIG. 3.

For example, the imaging unit 31 reads out images at low resolution and low bit depth to reduce power consumption, and the like in a normal state; and the inference unit 33 performs inference processing of detecting the position of a person (image region). When the inference result from the inference unit 33 changes, such as when the certainty factor of the inference result from the inference unit 33 increases, the parameter controller 81 supplies the imaging unit 31 with parameters for specifying the image region of the detected person as a region of interest (ROI), and causes the imaging unit 31 to read out the region of interest at high resolution and high bit depth. Thereafter, the inference processing is performed on an image with high resolution and high bit depth as the state of interest in the inference unit 33, thereby achieving accurate inference. When the certainty factor drops, the parameter controller 81 returns the imaging unit 31 to the normal state. In the normal state, the imaging unit 31 reads out pixel values discretely, and in a state of interest, a variation, for example, can be adopted in which the imaging unit 31 reads out pixel values fully.

### Inference Image Quality Correction Method Based on Teacher Image Quality

### First Example

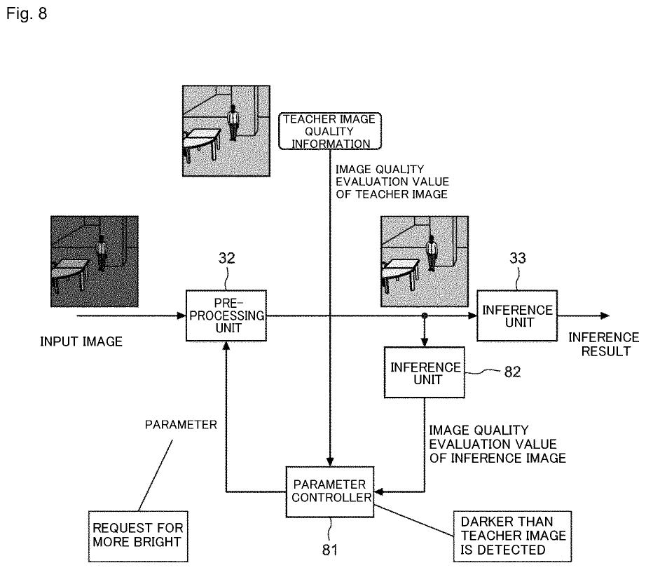

FIG. 8 is a diagram illustrating an inference image quality correction method (first example) based on a teacher image quality. In FIG. 8, a pre-processing unit 32 and an inference unit 33 correspond to the pre-processing unit 32 and the inference unit 33 of the inference device 11-2 in the second embodiment illustrated in FIG. 2. In FIG. 8, a parameter controller 81 includes the parameter derivation unit 54 and the pre-processing parameter update unit 56 of the inference device 11-2 in the second embodiment illustrated in FIG. 2. In FIG. 8, an image quality evaluation unit 82 corresponds to the image quality detection unit 51 of the inference device 11-2 in the second embodiment illustrated in FIG. 2.

The parameter controller 81 compares, for example, an image quality evaluation value of the teacher image, which is teacher image quality information supplied from the image quality detection unit 52 of the learning device 12-2 in FIG. 2, with an image quality evaluation value of the inference image, which is inference image quality information supplied from the image quality evaluation unit 82. The parameter controller 81 controls the pre-processing parameters to be supplied to the pre-processing unit 32 so that the teacher image and the inference image are adjusted to have the same image quality (substantially the same). For example, the image quality evaluation value is an average brightness value, and one of the pre-processing parameters to be supplied to the pre-processing unit 32 is a brightness gain. In this case, the parameter controller 81 sets the brightness gain to be supplied to the pre-processing unit 32 to a value of (the average brightness value of the teacher image)/(the average brightness value of the inference image). Thus, the inference image is corrected to have the same brightness as the teacher image, so that the inference accuracy in the inference unit 33 is improved.

### Second Example

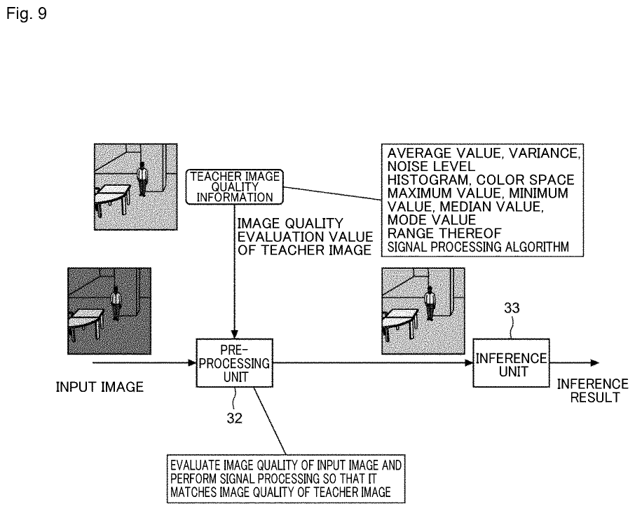

FIG. 9 is a diagram illustrating an inference image quality correction method (second example) based on a teacher image quality. In FIG. 9, a pre-processing unit 32 and an inference unit 33 correspond to the pre-processing unit 32 and the inference unit 33 of the inference device 11-2 in the second embodiment illustrated in FIG. 2. Note that FIG. 9 is referred to for an inference image quality correction method different from that of the inference device 11-2 in the second embodiment illustrated in FIG. 2. The pre-processing unit 32 acquires an image quality evaluation value of a teacher image, which is teacher image quality information supplied from the image quality detection unit 52 of the learning device 12-2 in FIG. 2. For example, the teacher image quality information may include an average value, a maximum value, a minimum value, a median value, a mode value, a variance, a histogram, a noise level, a color space, a signal processing algorithm, and the like for pixel values.

The pre-processing unit 32 performs image quality evaluation on an input image (inference image) supplied from the imaging unit 31 in FIG. 2 in the same manner as the learning device 12-2, and performs pre-processing so as to approach the image quality evaluation value of the teacher image. For example, for an image quality evaluation value being an average brightness value, the pre-processing unit 32 sets the brightness gain included in the pre processing to a value of (the average brightness value of the teacher image)/(the average brightness value of the inference image). Thus, the inference image is corrected to have the same brightness as the teacher image, so that the inference accuracy in the inference unit 33 is improved.

### Third Example

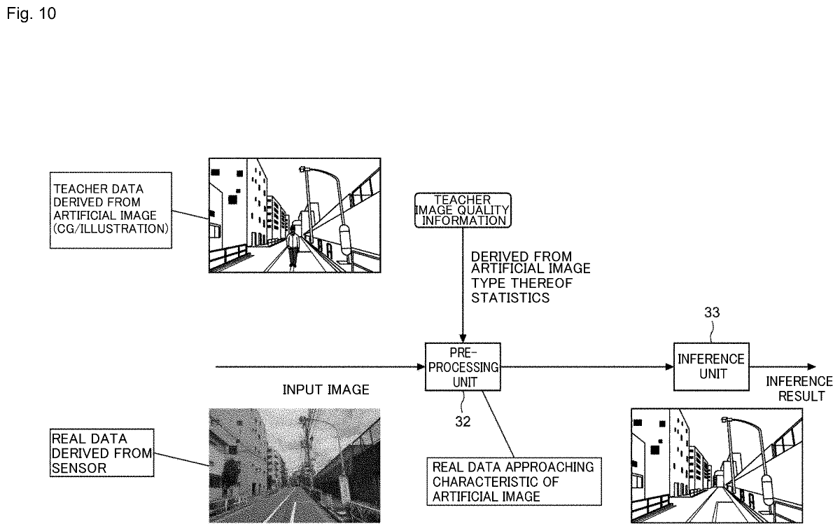

FIG. 10 is a diagram illustrating an inference image quality correction method (third example) based on a teacher image quality. In FIG. 10, a pre-processing unit 32 and an inference unit 33 correspond to the pre-processing unit 32 and the inference unit 33 of the inference device 11-4 in the fourth embodiment illustrated in FIG. 4. The pre-processing unit 32 acquires characteristic information of the teacher image, which is an artificial image supplied from the learning device 12-4 in FIG. 4. The pre-processing unit 32, the pre-processing unit 32 performs, based on the characteristic information of the teacher image, pre-processing on an input image (inference image) supplied from the imaging unit 31 in FIG. 4 so as to turn the input image into an artificial image similar to the teacher image, and supplies the resulting image as inference data to the inference unit 33. Thus, the inference image is corrected to the artificial image that is substantially the same as the teacher image, so that the inference accuracy in the inference unit 33 is improved.

### Parameters Available for Inference Image Quality Correction

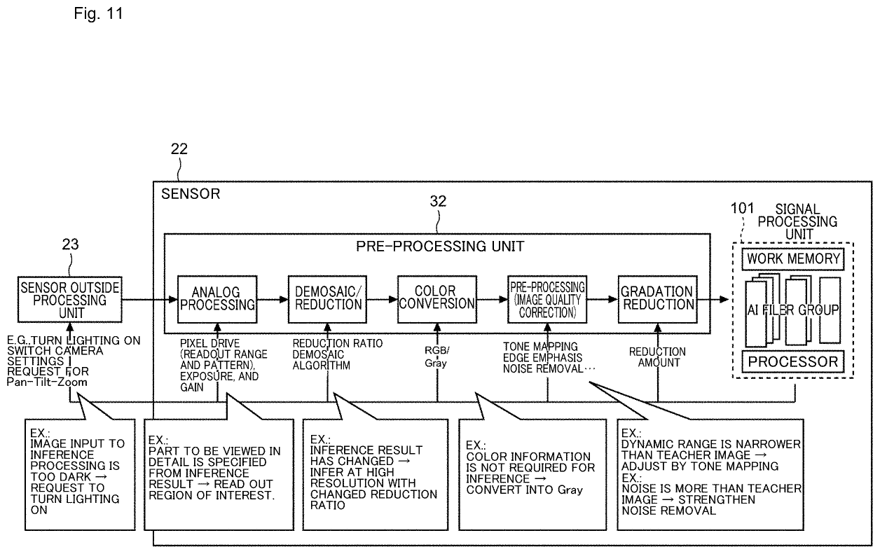

FIG. 11 is a diagram illustrating types (element values) of pre-processing parameters available for correction of inference image quality. In FIG. 11, a sensor 22, a pre-processing unit 32, and a signal processing unit 101 correspond to the sensor 22, the pre-processing unit 32, and the inference unit 33 of the inference devices 11-1 to 11-4 in FIGS. 1 to 4. The signal processing unit 101 is a processing unit that performs computation processing using an inference model, and includes a processor and a work memory. In the signal processing unit 101, a group of AI filters is virtually constructed by implementing an inference model having a NN structure. A sensor outside processing unit 23 is a processing unit separate from the sensor 22, and is a processing unit related to the imaging of the imaging unit 31 (a processing unit related to the image quality of the inference image).

In the pre-processing unit 32 in FIG. 11, the types of pre-processing to be performed by the pre-processing unit 32 are illustrated. The pre-processing unit 32 performs analog processing, demosaic/reduction processing, color conversion processing, pre-processing (image quality correction processing), gradation reduction processing, and the like. In the analog processing, pixel drive (control of the readout range and pattern), exposure, and gain control are performed. In the demosaic/reduction processing, a reduction ratio and a demosaic algorithm are set, and based on them, an image is demosaiced and reduced. In the color conversion processing, processing of color conversion of an image, for example, from BGR color space to grayscale is performed. In the pre-processing (image quality correction processing), processing is performed such as tone mapping, edge emphasis, and noise removal. In the gradation reduction processing, an amount of reduced gradation is set, and based on that amount, processing of gradation reduction is performed.

The image quality of the inference image can be corrected by controlling parameters for setting the processing contents of such processing performed by the pre-processing units 32, and any parameter may be controlled. The image quality of the inference image may be corrected by controlling parameters for the sensor outside processing unit 23, not limited to parameters related to the pre-processing in the sensor 22. The sensor outside processing unit 23 performs, for example, processing of switching on/off a lighting, processing of switching settings of a camera (imaging unit), and processing of controlling the pan/tilt and zoom of the camera. The image quality of the inference image may be corrected by controlling parameters related to such types of processing.

For example, when the inference image is dark, the lighting may be turned on by a parameter for the sensor outside processing unit 23. When a part to be viewed in detail is specified from the inference result, the region of interest may be set to a specified region by a parameter for the analog processing. When the inference result changes, and a high-resolution inference image with the reduction ratio changed by a parameter for the demosaic/reduction processing may be supplied to the inference unit 33 (signal processing unit 101). If color information is not required for the inference processing, a color inference image may be converted to a grayscale inference image by using a parameter for the color conversion processing. If the dynamic range of the inference image is narrower than that of the teacher image, tone mapping may be performed to expand the dynamic range by using a parameter for image quality correction processing. If the inference image has more noise than the teacher image, the noise removal may be strengthened by adjusting a parameter for the image quality correction processing.

### Configuration Example of Computer

The series of steps of processing described above can be performed by hardware or can be executed by software. When the series of steps of processing is performed by software, a program of the software is installed in a computer. Here, the computer includes a computer embedded in dedicated hardware or, for example, a general-purpose personal computer capable of implementing various functions by installing various programs.

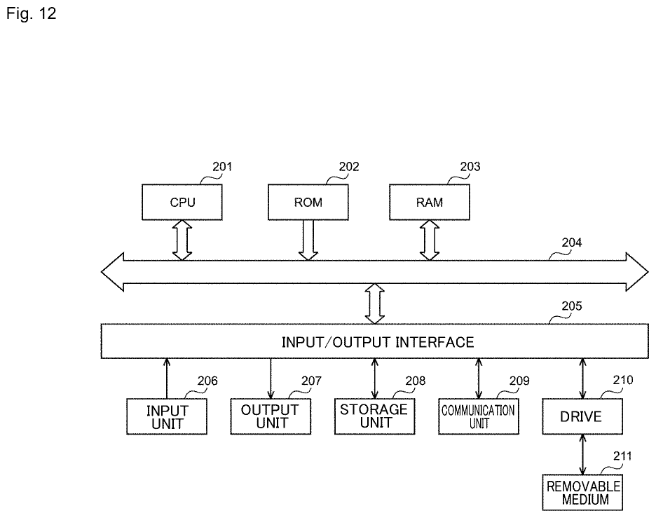

FIG. 12 is a block diagram illustrating a hardware configuration example of a computer that performs the above-described series of steps of processing according to a program.

In the computer, a central processing unit (CPU) 201, read-only memory (ROM) 202, and random access memory (RAM) 203 are connected to each other by a bus 204.

An input/output interface 205 is further connected to the bus 204. An input unit 206, an output unit 207, a storage unit 208, a communication unit 209, and a drive 210 are connected to the input/output interface 205.

Examples of the input unit 206 include a keyboard, a mouse, and a microphone. Examples of the output unit 207 include a display and a speaker. Examples of the storage unit 208 include a hard disk and non-volatile memory. Examples of the communication unit 209 include a network interface. The drive 210 drives a removable medium 211 such as a magnetic disk, an optical disc, a magneto-optical disk, or a semiconductor memory.

In the computer configured as described above, for example, the CPU 201 loads a program stored in the storage unit 208 into the RAM 203 via the input/output interface 205 and the bus 204 and executes the program, to perform the above-described series of steps of processing.

The program to be executed by the computer (the CPU 201) can be recorded on, for example, the removable medium 211 serving as a package medium for supply. The program can also be provided via a wired or wireless transmission medium such as a local area network, the Internet, or digital satellite broadcasting.

In the computer, by mounting the removable medium 211 on the drive 210, it is possible to install the program in the storage unit 208 via the input/output interface 205. The program can be received by the communication unit 209 via a wired or wireless transmission medium to be installed in the storage unit 208. In addition, the program can be installed in advance in the ROM 202 or the storage unit 208.

The program executed by a computer may be a program that performs processing chronologically in the order described in the present specification or may be a program that performs processing in parallel or at a necessary timing such as a called time.

The processing to be performed by the computer according to the program described herein may not necessarily be performed chronologically in the order described as the flowcharts. In other words, the processing to be performed by the computer according to the program also includes processing that is performed in parallel or individually (e.g., parallel processing or processing by objects).

The program may be a program processed by one computer (processor) or may be distributed and processed by a plurality of computers. Furthermore, the program may be a program transmitted to a remote computer to be executed.

Moreover, in the present specification, a system means a collection of a plurality of constituent elements (including devices and modules (components)) regardless of whether all the constituent elements are contained in the same casing.

Accordingly, a plurality of devices accommodated in separate casings and connected via a network and one device in which a plurality of modules are accommodated in one casing are all systems.

For example, a configuration described as one device (or processing unit) may be divided and configured as a plurality of devices (or processing units). On the other hand, the configuration described above as a plurality of devices (or processing units) may be collectively configured as one device (or processing unit). Of course, a configuration other than the above may be added to the configuration of each device (or each processing unit). Furthermore, a part of the configuration of a device (or processing unit) may be included in the configuration of another device (or another processing unit) as long as the configuration or operation of the system as a whole is substantially the same.

For example, the present technology may have a cloud computing configuration in which one function is shared with and processed by a plurality of devices via a network.

For example, the above-described program can be executed in any device. In this case, the device only needs to have necessary functions (functional blocks, and the like) and to be able to obtain necessary information.

For example, for a program executed by a computer, processing of steps describing the program may be performed chronologically in order described in the present specification or may be performed in parallel or individually at a necessary timing such as the time of calling. In other words, the processing of the respective steps may be performed in an order different from the above-described order as long as there is no contradiction. Furthermore, the processing of the steps describing this program may be performed in parallel with processing of another program, or may be performed in combination with the processing of the other program.

The present technology described as various modes in the present description may be implemented independently alone as long as no contradiction arises. Of course, any plurality of technologies may be implemented together. For example, some or all of the present technologies described in several embodiments may be implemented in combination with some or all of the present technologies described in the other embodiments. A part or all of any above-described present technology can also be implemented together with another technology which has not been described above.

### Combination Example of Configuration

The present technology can also be configured as follows.

(1)
An information processing device including:
an inference unit that performs inference processing on an input inference image; and
a processing unit that corrects an image quality of the inference image based on an image quality of a teacher image used for learning in the inference unit.
   (2)
The information processing device according to (1), wherein the processing unit corrects the image quality of the inference image so that the inference image to be input to the inference unit has an image quality that is substantially the same as the image quality of the teacher image.
   (3)
The information processing device according to (1) or (2), wherein the processing unit
corrects the image quality of the inference image by comparing the image quality of the inference image with the image quality of the teacher image.
   (4)
The information processing device according to (3), including an image quality detection unit that detects the image quality of the inference image to be input to the inference unit.
   (5)
The information processing device according to any one of (1) to (4), wherein the processing unit
corrects the image quality of the inference image by changing, based on the image quality of the teacher image, an operation of pre-processing to be performed on the inference image before being input to the inference unit.
   (6)
The information processing device according to (5), wherein the processing unit acquires processing contents of pre-processing performed on the teacher image as information on the image quality of the teacher image, and corrects the image quality of the inference image based on processing contents of the pre-processing.
   (7)
The information processing device according to any one of (1) to (4), including an imaging unit that captures the inference image, wherein the processing unit corrects the image quality of the inference image by changing an operation of the imaging unit based on the image quality of the teacher image.
   (8)
The information processing device according to (7), wherein the processing unit acquires an operation of a second imaging unit that has captured the teacher image as information on the image quality of the teacher image, and corrects the image quality of the inference image based on the operation of the second imaging unit.
   (6)
The information processing device according to any one of (1) to (8), wherein the processing unit
corrects the image quality of the inference image based on an inference result of the inference unit.
   (10)
The information processing device according to any one of (1) to (9), wherein the processing unit
corrects the image quality of the inference image based on a certainty factor for an inference result of the inference unit.
   (11)
The information processing device according to (10), wherein the processing unit corrects the image quality of the inference image so as to increase the certainty factor.
   (12)
The information processing device according to any one of (1) to (11), wherein the inference unit performs inference processing using an inference model learned by a machine learning technology.
   (13)
The information processing device according to any one of (1) to (12), wherein the inference unit is mounted in a chip that is the same as where an imaging unit that captures the inference image is mounted.
   (14)
An information processing device including a supply unit that supplies, to an inference device that implements an inference model generated by a machine learning technology, information on an image quality of a teacher image used to learn an inference model.
   (15)
The information processing device according to (14), including an image quality detection unit that detects the image quality of the teacher image.
   (16)
The information processing device according to (14) or (15), including a learning unit that learns the inference model using the teacher image.
   (17)
An information processing method performed by an information processing device that includes an inference unit and
a processing unit,
the information processing method including:
by the inference unit, performing inference processing on an input inference image; and
by the processing unit, correcting an image quality of the inference image based on an image quality of a teacher image used for learning in the inference unit.
   (18)
A program causing a computer to function as:
an inference unit that performs inference processing on an input inference image; and
a processing unit that corrects an image quality of the inference image based on an image quality of a teacher image used for learning in the inference unit.

Note that embodiments of the present disclosure are not limited to the above-mentioned embodiments and can be modified in various manners without departing from the scope and spirit of the present disclosure. Moreover, the effects described in this specification are merely examples and are not limited, and other effects may also be present.

### REFERENCE SIGNS LIST

1-1, 1-2, 1-3, 1-4 Inference system
11-1, 11-2, 11-3, 11-4 Inference device
12-1, 12-2, 12-3, 12-4 Learning device
21 Optical system
22 Sensor
23 Sensor outside processing unit
31 Imaging unit
32 Pre-processing unit
33 Inference unit
34 Memory
35 Imaging parameter input unit
36 Pre-processing parameter input unit
37 Inference model input unit
41 Optical system
42 Imaging unit
43 Pre-processing unit
44 Learning unit
51 Image quality detection unit
52 Image quality detection unit
53 Image quality information input unit
54 Parameter derivation unit
55 Imaging parameter update unit
56 Pre-processing parameter update unit
61 Artificial image acquisition unit
81 Parameter controller
82 Image quality evaluation unit
101 Signal processing unit

1. An information processing device comprising:
an inference unit that performs inference processing on an input inference image; and
a processing unit that corrects an image quality of the inference image based on an image quality of a teacher image used for learning in the inference unit.

2. The information processing device according to claim 1, wherein the processing unit corrects the image quality of the inference image so that the inference image to be input to the inference unit has an image quality that is substantially the same as the image quality of the teacher image.

3. The information processing device according to claim 1, wherein the processing unit corrects the image quality of the inference image by comparing the image quality of the inference image with the image quality of the teacher image.

4. The information processing device according to claim 3, comprising an image quality detection unit that detects the image quality of the inference image to be input to the inference unit.

5. The information processing device according to claim 1, wherein the processing unit corrects the image quality of the inference image by changing, based on the image quality of the teacher image, an operation of pre-processing to be performed on the inference image before being input to the inference unit.

6. The information processing device according to claim 5, wherein the processing unit acquires processing contents of pre-processing performed on the teacher image as information on the image quality of the teacher image, and corrects the image quality of the inference image based on processing contents of the pre-processing.

7. The information processing device according to claim 1, comprising an imaging unit that captures the inference image, wherein
the processing unit corrects the image quality of the inference image by changing an operation of the imaging unit based on the image quality of the teacher image.

8. The information processing device according to claim 7, wherein the processing unit acquires an operation of a second imaging unit that has captured the teacher image as information on the image quality of the teacher image, and corrects the image quality of the inference image based on the operation of the second imaging unit.

9. The information processing device according to claim 1, wherein the processing unit corrects the image quality of the inference image based on an inference result of the inference unit.

10. The information processing device according to claim 1, wherein the processing unit corrects the image quality of the inference image based on a certainty factor for an inference result of the inference unit.

11. The information processing device according to claim 10, wherein the processing unit
corrects the image quality of the inference image so as to increase the certainty factor.

12. The information processing device according to claim 1, wherein the inference unit performs inference processing using an inference model learned by a machine learning technology.

13. The information processing device according to claim 1, wherein the inference unit is mounted in a chip that is the same as where an imaging unit that captures the inference image is mounted.

14. An information processing device comprising a supply unit that supplies, to an inference device that implements an inference model generated by a machine learning technology, information on an image quality of a teacher image used to learn the inference model.

15. The information processing device according to claim 14, comprising an image quality detection unit that detects the image quality of the teacher image.

16. The information processing device according to claim 14, comprising a learning unit that learns the inference model using the teacher image.

17. An information processing method performed by an information processing device that includes an inference unit and
a processing unit,
the information processing method comprising:
by the inference unit, performing inference processing on an input inference image; and
by the processing unit, correcting an image quality of the inference image based on an image quality of a teacher image used for learning in the inference unit.

18. A program causing a computer to function as:
an inference unit that performs inference processing on an input inference image; and
a processing unit that corrects an image quality of the inference image based on an image quality of a teacher image used for learning in the inference unit.
